(19) United States
(12) Patent Application Publication
(10) Pub. No.: US 2016/0048822 A1
(43) Pub. Date: Feb. 18, 2016

(54) Method and System for Delivering Funding Options to a User

(71) Applicant: MasterCard International Incorporated, Purchase, NY (US)

(72) Inventor: John Forrest, Dublin (IE)

(21) Appl. No.: 14/823,759

(22) Filed: Aug. 11, 2015

(30) Foreign Application Priority Data
Aug. 15, 2014 (GB) 1414499.2

(51) Int. Cl. G06Q 20/22; G06Q 20/12; G06Q 20/32; G06Q 30/06

(52) U.S. Cl. CPC G06Q 20/227; G06Q 30/0635; G06Q 20/12; G06Q 20/322

(57) ABSTRACT

A method and system for delivering funding options to a user, with the method being performed by a mobile device, includes operating a processor associated with the mobile device to: allow a user to select an item for purchase; collate data from one or more payment service provider sources to inform a user of the mobile device of any funding options available; allow user selection of the preferred funding option; and fulfill the preferred funding option.

### CROSS-REFERENCE TO RELATED APPLICATIONS

This application claims foreign priority to United Kingdom Patent Application No. 1414499.2, filed 15 Aug. 2014, the complete disclosure of which is expressly incorporated herein by reference in its entirety for all purposes.

### FIELD OF THE INVENTION

The present disclosure relates to a payment method and system. More particularly, it relates to a method and system for paying for an item using a mobile device while allowing the purchaser to choose from a variety of funding sources in real time.

### BACKGROUND OF THE DISCLOSURE

Typically consumers use cash, debit cards or credit cards when making purchases or conducting transactions in real or virtual retail outlets. Credit or debit cards are ubiquitous nowadays, and for years such cards have included a magnetic stripe on which the relevant account number is stored. Traditionally, to consummate a purchase transaction with such a card, the card is swiped through a magnetic stripe reader that is part of a point of sale (POS) terminal. The account number is read by the reader from the magnetic stripe. The account number is then used to route a transaction authorisation request that is initiated by the POS terminal. Card-based transactions are typically performed across multiple channels of commerce. For example, card-based transactions may be performed in person at a retail outlet, via a computer connected to the Internet, via a mobile device such as a smartphone and/or via a call centre.

Electronic commerce, such as online shopping, has been increasingly common since the beginning of the Internet. Online shopping websites generally provide a user interface for customers to select items or services for purchase. After the customer has selected items for purchase, the customer typically can choose from multiple payment/credit options to purchase the products. Two conventional payment/credit options supported by online merchants include using a financial account, for example, a credit card or current account, and using a third party payment service provider. The customer typically enters details of their credit or debit card in the user interface when purchasing items.

Lately, there has been growing interest in electronic or “cash-less” retail payment systems which do not rely on traditional credit or debit cards. Such systems can expedite payment. Electronic commerce transactions can be effected by using a digital wallet, which refers to an electronic device that allows an individual to make electronic purchases. This can include purchasing items on-line with a computer or using a mobile device to purchase something at a store. Increasingly, digital wallets are being made not just for basic financial transactions but also to authenticate the holder's credentials. For example, a digital wallet can be used to verify the age of the purchaser.

The ability to make payments using mobile devices provides a further advantage in that the consumer does not have to carry physical funding instruments, such as credit cards, cash, and debit cards. Conventional systems for making electronic retail payments include “contactless” credit and debit card systems, which are proprietary systems developed by banks and/or credit card companies that use electronically equipped cards or other electronic devices capable of transmitting and receiving radio frequency (RF) signals. Such system provides cardholders with a more user-friendly means of completing a credit/debit transaction by bringing a contactless-enabled payment card or other payment device, such as a key fob, proximal to a point-of-sale terminal reader, rather than swiping or inserting a card.

Currently when a customer is making a large purchase, there are a variety of ways to fund and effect the payment for goods. A customer might be offered in-store credit for the purchase, a new store-branded credit card, offered credit by his/her bank, offered credit by a third party institution or simply avail of an existing credit agreement or payment device, or fund the transaction from savings.

In a typical transaction using a credit or debit card, a cardholder wishing to complete a transaction (or make a payment) provides a card number together with other card details (such as a card expiry date, card code verification (CCV) number etc.) to a merchant at a point of sale (POS). The merchant transmits the card number and the details to an ‘acquirer’, i.e. a financial institution that facilitates and processes card payments made to the merchant. The acquirer then transmits an authorization request via a payment card network to an issuer or provider of the card used to make the payment.

The issuer processes the received request and determines whether or not the request is allowable. If the issuer determines that the payment request is allowable, an authorization response is transmitted via the payment card network to the acquirer and transfer of the payment amount to the merchant's account is initiated. Responsive to receiving the authorization response from the issuer, the acquirer communicates the authorization response to the merchant. In this manner, a card number may be used to effect a card payment to a merchant.

There are multiple different types of payment cards available on the market, and multiple ways to fund and effect the payment for goods. In some cases, a payment card may serve a specific purpose. For example, a payment card may be configured to enable a customer to make payments and/or withdraw cash in one or more foreign currencies. Additionally or alternatively, a payment card may be a virtual credit card enabling a user to purchase items without exposing the user to the possibilities of credit card fraud. For example, the number of payments and/or the amount for which payments can be made using a virtual credit card may be limited.

Mobile wallet applications on a mobile device allow the user to select one of a plurality of stored cards in order to make a payment, as many consumers use more than one card in a given day. However, with mobile devices acting as payment devices, selecting a particular card often involves unlocking the phone, launching the mobile wallet application, selecting the card and then tapping the phone. This is a lengthy process that can prolong the purchasing transaction. When faced with a lengthy multi-step process of selecting a card on their mobile device or simply pulling the desired card out of their physical wallet, the consumer may prefer to reach for their actual physical wallet and card.

In view of the above, there are many situations where it is desirable to provide increased flexibility to fund (or pay for) purchases using a mobile device. In particular, it would be advantageous to configure a mobile device such as a smartphone to allow a user to complete a contactless payment transaction quickly and efficiently. An improved method for providing funding options to a user would therefore be desirable.

### SUMMARY OF THE INVENTION

The present disclosure provides a computer-implemented method for delivering funding options to a user, the method being performed by a mobile device and comprising operating a processor associated with the mobile device to: allow a user to select an item for purchase; collate data from one or more payment service provider sources to inform a user of the mobile device of available funding options; allow user selection of a preferred funding option; and fulfill the preferred funding option.

Also provided is a mobile device configured to deliver funding options to a user; the mobile device includes a memory; a user interface; and a processor configured to: allow a user to select an item for purchase; collate data from one or more payment service provider sources to inform a user of the mobile device of available funding options; allow user selection of a preferred funding option; and fulfill the preferred funding option.

Furthermore, also provided is a non-transitory computer readable medium comprising computer executable instructions which when executed by a mobile computing device cause the mobile computing device to perform the method of: allowing a user to select an item for purchase; collating data from one or more payment service provider sources to inform a user of the mobile device of available funding options; allowing user selection of a preferred funding option; and fulfilling the preferred funding option.

### BRIEF DESCRIPTION OF THE DRAWINGS

FIG. 1 is a diagram of a payment system according to an embodiment of the present disclosure;

FIG. 2 is a flow diagram depicting an exemplary method for delivering funding options to a user, according to an embodiment of the present disclosure;

FIG. 3 is a sample screenshot of a user interface of a mobile device showing different funding options, according to an embodiment of the present disclosure;

FIG. 4 is a diagram showing a user interface of a mobile device showing different funding options, according to another embodiment of the present disclosure; and

FIG. 5 is a block diagram illustrating an exemplary configuration of a mobile device according to an embodiment of the present disclosure.

### DETAILED DESCRIPTION

The present disclosure provides a computer-implemented method and system for delivering funding options to a user.

A computer-implemented method is provided whereby a customer choosing an item for purchase from a merchant is presented with one or more available funding options which may include, for example, payment/credit options. The item for purchase may be selected in a real or virtual store, such as a retail store, online shopping mall, or the like. The customer selects the preferred funding option. The method is then configured to fulfill the transaction option selected and may also fulfill any data collection required (e.g. loan application details). In the context of the present disclosure, it will be understood that the term ‘funding option’ refers to the specific way in which the item selected is to be purchased, and not merely which payment service provider is to be used. That is, each of a plurality of banking institutions may provide one or more ways of paying for the item. Examples of these funding options may include:
Pay now—(Debit Card)
Pay Later—(Credit Card)
Pay from Bank Credit Line
In-store Credit
Hire Purchase
Loan

The method and system may be primarily aimed at users of mobile devices such as smartphones. For example, the method may be embodied as part of an application or ‘payment finder app’ on the mobile device. The payment finder app may be manually activated by the user, or automatically activated on selection of an item for purchase as will be described later. Such users may or may not have payment cards such as debit or credit cards, but it is the ability to select a funding option from a list of funding options presented to the user on the mobile device which is key to the present disclosure. For this reason, the customer making the purchase, which may be a cardholder, is also referred to as the more generic term “user.”

The method may be configured to allow the merchant, the cardholder's bank (or banks), and third party payment service providers to present to the cardholder or user, the list of transaction options that they wish to offer to the user for the particular purchase. The user selects the funding option of their choice. The selection of the preferred funding option triggers the payment using existing payment networks or exchange of data to allow payment fulfillment offline or both. For example, one method of payment fulfillment offline may be an in-store credit facility.

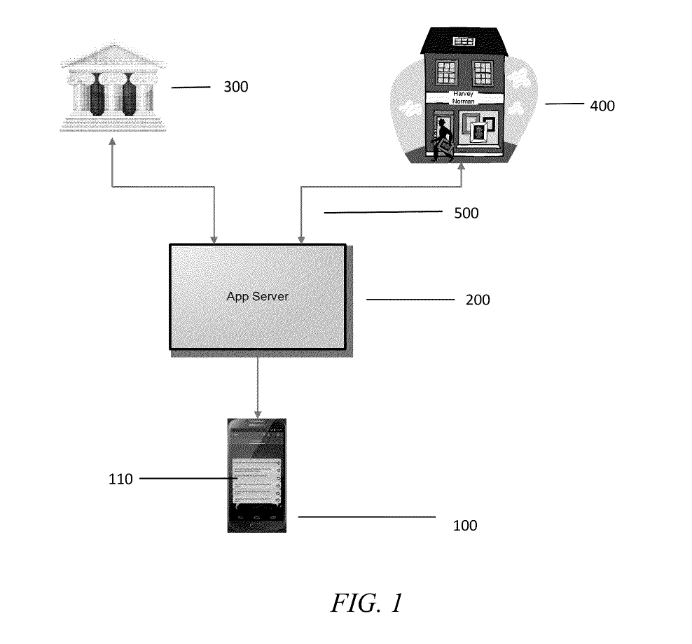

FIG. 1 is a diagram illustrating a payment system 50 according to an embodiment of the present disclosure. Referring to FIG. 1, the system 50 may include a payment finder app 110 running on a mobile device 100, and an application server 200 for communicating between the mobile device 100 and a payment service provider terminal 300, such as a bank or other financial institution, and a merchant terminal 400 to which a payment is to be made. The merchant may be any seller that provides items, including digital goods, and/or services, referred to generally as items, to the user for purchase. The item to be purchased may be selected in a physical store such as a shop or retail outlet where the user is present, or may be selected remotely via a virtual, online, or home shopping environment. The mobile device 100 may be a smart phone, computing tablet, or other computing device having mobile communication capabilities.

The application server 200 is configured to transmit a payment request to the payment service provider terminal 300 over a network 500. The merchant terminal 400 may comprise, or be comprised within, a physical terminal. For example, the merchant terminal 400 may comprise one or more of: a portable computing device (e.g. a laptop computer, a smartphone, a tablet computer etc.); a desktop computer; a Point of Sale (POS) or merchant terminal, for example located a terminal located at a physical point of sale such as a shop or restaurant. Alternatively, the merchant terminal 400 may be a virtual terminal associated with a virtual Point Of Sale, e.g. a POS at which online purchases or payments may be made. The merchant terminal 400 may be an application running on a device such as a portable telephone or computer (e.g. a ‘smartphone’ or tablet computer).

The payment service provider terminal 3 and the merchant terminal 300 may communicate with the mobile device 100, via the server 200, over the network 500 using any suitable means, for example but not limited to wireless or cellular network, Bluetooth™; Near-Field Communication (NFC); Infra-Red (IR) Communication; or Magnetic Induction.

The network 500 may comprise any network across which communications can be transmitted and received. For example, the network 500 may comprise a wired or wireless network. The network 500 may, for example, comprise one or more of: the Internet; a local area network; a mobile or cellular network; a mobile data network or any other suitable type of network.

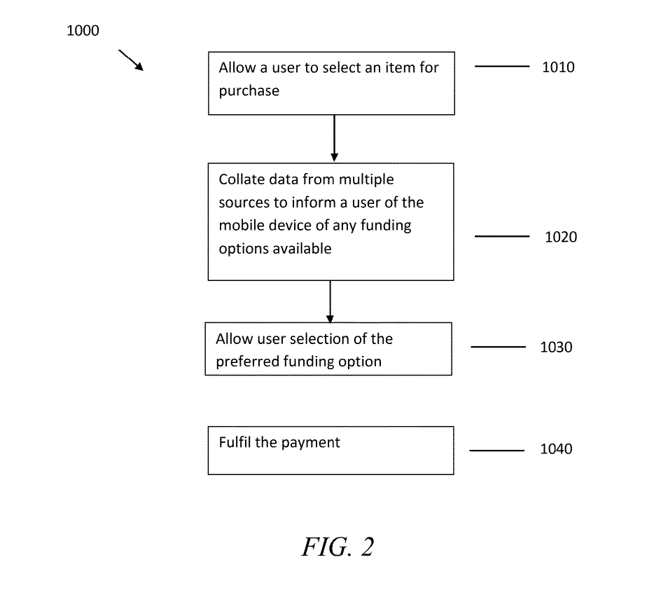

FIG. 2 is a flow diagram depicting an exemplary method 1000 for delivering funding options to a user, according to an embodiment of the present disclosure. The method is performed by a processor associated with a mobile device. Referring to FIG. 2, the method 1000 comprises operating the processor associated with the mobile device to: allow a user to select an item for purchase 1010, collate data from one or more payment service provider sources to inform a user of the mobile device of any funding options available 1020; allow user selection of the preferred funding option 1030; and fulfill the payment 1040. The one or more payment service provider sources may comprise at least one payment service provider such as the user's own bank, other banks, and the merchant from which the purchase is being made. For example, the user's own bank may present several funding options such as credit card payments spread over a varying periods of time, or various overdraft payments plans.

The payment finder app 110 may be configured to receive information about an item selected for purchase. An item may be selected for purchase from a merchant app associated with any merchant or seller that provides items, including digital goods, and/or services, referred to generally as items, to the user for purchase. The merchant app may be configured to be selected on the mobile device 100, such as by tapping, to view items available for purchase within the app. In an embodiment of the present disclosure, the payment finder app 110 on the user's mobile device 100 may be automatically launched when an item for purchase is selected on the mobile device 100 via the merchant app. The item for purchase may be selected by capturing an identifier associated with the item for purchase. For example, the payment finder app 110 may be automatically launched by scanning or otherwise capturing an identifier associated with the item, such as a barcode or a Quick Response (QR) code. In other embodiments, the mobile device may be configured to capture an image of the identifier, to receive a speech identifier of the item into the mobile device 100, or configured to allow the identifier to be entered into a user interface on the mobile device 100. Item selection may include selecting a visual identifier associated with the item, such as a button or link, where the button or link includes an indication to purchase the item, price of the item, description or information about the item, and/or other information as appropriate. Selecting the item may then display to the user on the mobile device 100 information or additional information about the item. For example, a previous content screen may be replaced by a screen with a description of the item to be purchased, and the amount involved. This information page, in another embodiment, may be a pop up or overlay of the content screen, which allows the user to remain on a main content page.

It will be understood that item selection can be effected locally or remotely. For example, item selection may be effected in a physical retail store as described above.

Alternatively, an item for purchase may also be selected in a home or online shopping environment. This enables users to instantly select desired items with the mobile device 100 while viewing services on television or the Internet. The home or online shopping environment may utilise barcode scanning technology and mobile devices. In a home or online shopping environment, the user may also have the capability to select an item for purchase using the methods described above. For example, the user may use the mobile device 100 to scan a barcode associated with anything being sold and displayed on screen. When the home or online service displays a product on-screen, a barcode may also be displayed associated with the product being sold. To select the item, the user may utilise a camera-equipped mobile device to scan the on-screen barcode. The barcode may be located on a television, computer monitor, PDA screen, other mobile device screen, etc. It should be obvious to the person skilled in the art that the screen may be any screen capable of being scanned.

Once the item is selected for purchase by the user, a payment request may be electronically communicated or transmitted to one or more payment service providers 300 from the mobile device 100 via the application server 200. The one or more payment service providers 300 may include the user's own bank, the merchant itself, and third party payment service providers. The payment request may include the mobile number associated with the mobile device 100 or other device identifier. This allows the user to be identified. Other information in the payment request may include the amount of the item being purchased and a description of the item. The payment request received by the payment service provider 300 may include an amount, and an identifier for a user account with the payment service provider 300, such as a mobile number. Additional information may be included as appropriate or desired, such as merchant information, item information, etc. Merchant information may also be conveyed to the payment service provider 300.

The method may include a determination as to whether the user can be authenticated or verified. This may include determining whether the number contained in the payment request matches a phone number associated with the user with the one or more payment service providers 300. A user may be required to have an account with the one or more payment service providers 300, which would include the payment service provider 300 having stored information about the user, such as the mobile number(s) associated with the mobile device 100, user name, billing address, user identifier, and/or a password or PIN. If the user does not have an account with one of the payment service providers, the user may be required to authenticate themselves before being offered one or more funding options. Such authentication may be effected by providing the above information.

As part of the authentication process, the one or more payment service providers 300 may generate a one-time use token and transmit the token to the user's messaging port on the mobile device 100. The token may include a unique identifier, which may be stored and associated with the transaction or payment request. The token is received at the mobile device 100, which then verifies the token's authenticity. The token may be transmitted back to the one or more payment service providers 300 to confirm or authenticate the user.

If the user cannot be authenticated, a notification may be sent electronically to the mobile device 100 that made the payment request or to another user device on record for the user. The notification may include a message that the payment request has been denied, such as by text or voice.

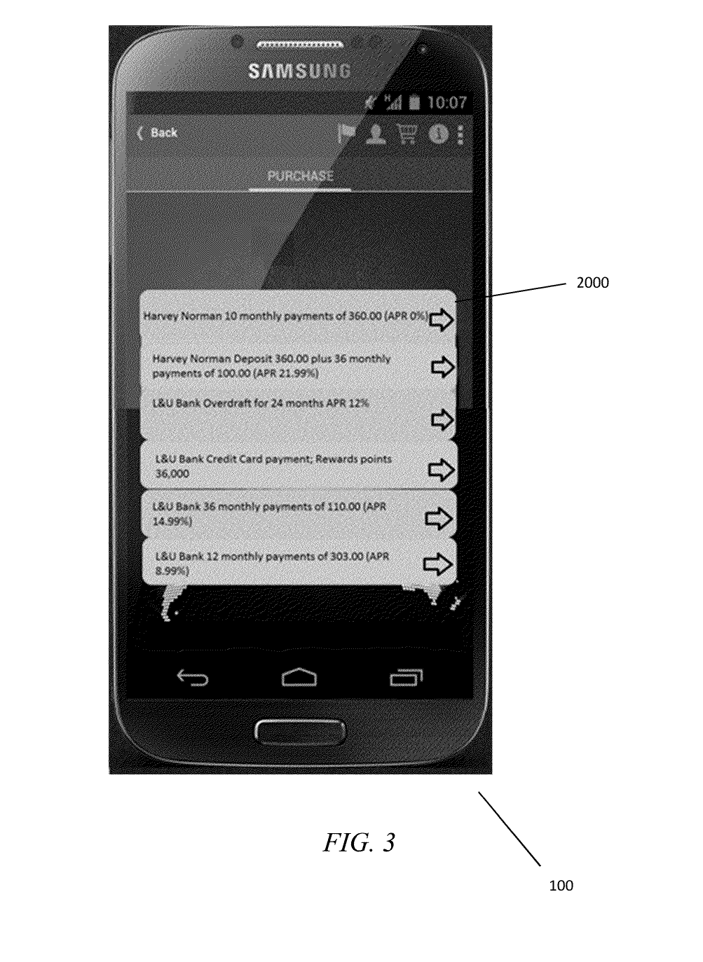

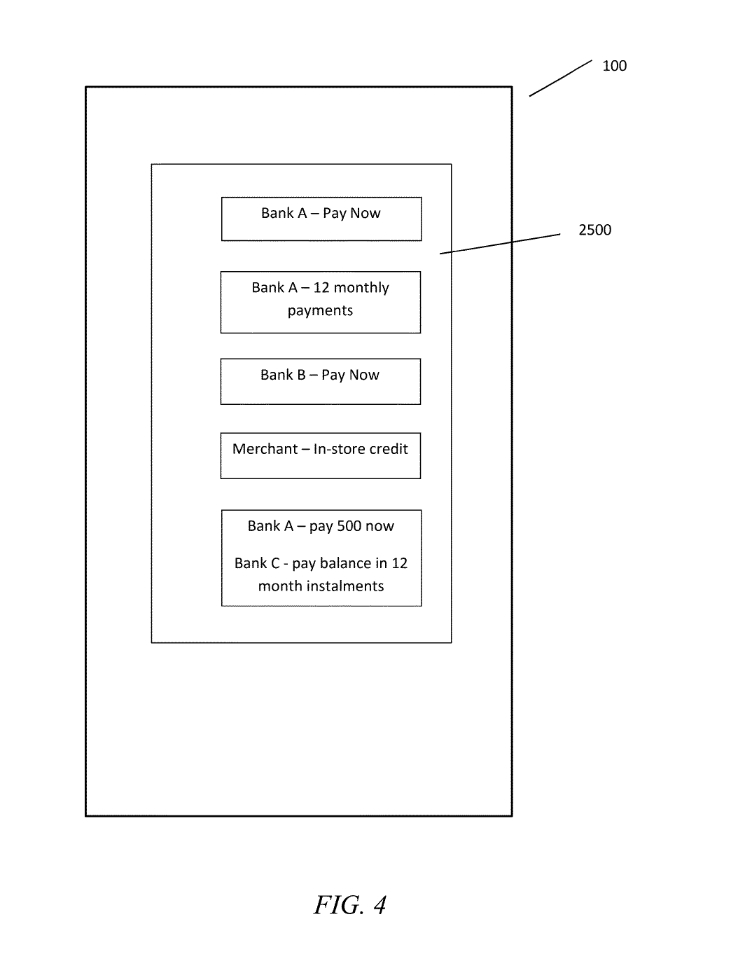

If the user is authenticated, each of the payment service providers 300 which has authenticated the user may be configured to provide one or more funding options to the user. The one or more funding options may be provided on a user interface of the mobile device 100. Each of the one or more funding options displayed on the user interface may comprise the name of the payment service provider and the terms and conditions of the respective funding option, as illustrated in FIG. 3. For example, the terms and conditions may comprise the interest rate and/or the number of monthly or weekly payments. The one or more funding options may be provided in a list format. Examples of these funding options include: Pay now—(Debit Card), Pay Later—(Credit Card), Pay from Bank Credit Line, In-store Credit, Hire Purchase, and Loan. One or more of these funding options may be provided by the user's own bank if applicable, the merchant itself, and another payment service provider such as a third party bank. The one or more funding options may include an option of paying for the transaction using one or more payment service providers. That is, the cost may be spread between multiple payment service providers, as illustrated in FIG. 4. FIG. 4 is a diagram showing a user interface 2500 of a mobile device 100 showing different funding options, according to another embodiment of the present disclosure. For example, if the cost of an item for purchase is 1000, the cost may be split by paying 500 to Bank A and 500 to Bank B. In another embodiment, the one or more funding options may include an option of conducting the transaction using one or more transaction types. For example, a funding option may be presented to the user that comprises paying half the amount now, and half the amount in installments over a certain time period. It will be understood by the skilled person, that the one or more funding options may comprise an option with multiple payment service providers and multiple transaction types.

The one or more payment service providers 300 may determine whether the payment request is approved or denied. The payment service provider 300 may access the user's account with the payment service provider 300 to determine whether there are any restrictions, limitations, or other information that may affect the payment request. For example, the account may be past due, such that any payment requests on the account would be denied. The account may also have a limit or maximum as to an individual or total amount. If the payment request is higher than this limit, the request may be denied. Further, one or more of the funding options may be configured according to at least one of the following: the cost of the item for purchase, the credit rating of the user, and an account balance of the user. For example, a user with a low credit rating may be presented with limited credit funding options if any. These and other factors, such as any risk analysis, may contribute to the decision whether to approve, adapt or deny the payment request. The one or more approved funding options may be listed according to the payment service provider 300. For example, funding options provided by the user's own bank may be provided at the top of a list as these may be the most attractive funding options. The remaining funding options if any may then be presented in the list following the funding options provided by the user's bank. In another embodiment, the

In an embodiment of the present disclosure, a digital wallet provided on the mobile device 100 may be configured to effect payment. The digital wallet may be configured to be associated with the payment finder app 110 on the mobile device. The digital wallet enables storage of one or more records that can be used for online and offline purchases. Each record may include or be associated with a financial account, such as a credit card account, a debit card account, a checking account, a savings account, a loyalty rewards account, or other type of account that can be used to make a purchase. The digital wallet can store, for each record, information associated with the financial account for that record. For example, the user may save a record for each of their bank accounts in the digital wallet. This payment information can include a financial account identifier, for example, account number, card number, an expiration date of one or more financial cards associated with the financial account, and a billing address for the account. The payment information may also include information associated with the user, such as name, contact information, for example, residential address, phone number, e-mail address, demographic information, or any other suitable information associated with the user. The payment information also may include shipping information, such as one or more shipping addresses, preferred shipping provider(s), and preferred shipping method(s), for example, ground, air, expedited, signature confirmation, or other shipping method. The payment information for each record may be maintained by the digital wallet and stored in a data storage unit such as a memory on the mobile device 100.

The user may interact with a user interface provided by the digital wallet to add, modify, or remove payment information to or from the digital wallet. For example, in the case where one or third party payment service providers 300 pushes a funding option to the mobile device 100, a new record may be required to be created in the digital wallet in order to facilitate fulfilling the funding option if chosen. The creation of a new record in the digital wallet may involve inserting personal details and other registration information identifying the user.

For example, the information may comprise one or more of the user's name; address; date of birth; telephone number; email address or any other information relating to the user. The registration information may comprise one or more forms of nationally or internationally recognised identification documents such as a passport, driving license, government identification card etc. The registration information may be referred to as ‘Know Your Customer’ (KYC) information. Additionally or alternatively, the registration information may comprise an indication of the user's address and/or ‘proof’ or evidence of the user's address. For example, the registration information may comprise one or more utility bills, bank statements, or any other documentation providing evidence that the user resides at an indicated address.

The registration information may additionally or alternatively comprise any other information relating to the user and/or the user's financial situation. For example, the registration information may comprise an indication of the user's social security number and/or an indication of one or more financial institutions or banks used by the user.

The method may comprise determining whether the received registration information meets a predefined criterion. The predefined criterion may be any suitable criterion defining a number or type of registration information required. For example, the predefined criterion may be a criterion defined by, or in association with, or on behalf of regulatory authorities. Additionally or alternatively, the predefined criterion may be a criterion defined by, or in association with, or on behalf of, one or more financial institutions.

If the payment request is denied, the payment service provider 300 may communicate the decision to the mobile device 100. However, if, the payment request is approved by the payment service provider 300, the funding option may be presented on a graphical user interface of the mobile device 100.

In step 1030, the user selects the preferred funding option from the one or more funding options available. The available funding options may be presented on a user interface of the mobile device 100. The payment finder app 110 may be configured to allow the user to select the preferred funding option from the user interface on the mobile device 100, such as by tapping the preferred option. The selection of the preferred funding option may trigger the payment fulfillment in step 1040. Fulfilling the payment may include the payment service provider 300 adding the charge or amount to the account of the user. A merchant account may be credited the purchase amount, by the payment service provider 300. The payment service provider 300 may debit an account or otherwise bill the user the appropriate amount. The fulfilling the payment may comprise receiving from the payment service provider 300 notification of an addition of a charge or amount corresponding to the cost of the item to the account of the user. The method may also comprise authorising the payment service provider to credit an account associated with the merchant with the purchase amount. The payment may be fulfilled using one of a plurality of records stored in a digital wallet on the mobile device 100. These records may correspond to respective accounts of the user with one or more payment service providers. That is, the payment may be effected using existing payment networks. Alternatively or in conjunction with, data may be exchanged to allow payment fulfillment offline. In this regard, user data may be provided from the mobile device 100 to the payment service provider providing the selected funding option to fulfill any data collection required. Such data collection may be for a loan application or for an in-store credit facility.

Once the funding option is fulfilled, the payment service provider 300 may then notify the user via the mobile device 100 and/or the merchant. For example, the payment service provider 300 may send a mobile payment confirmation to the user's mobile device 100 and to the payment finder app 110, either separately or through the mobile SDK. A digital receipt may also be sent to the user's mobile device 100.

The user may then receive the benefits of the purchased item. For example, the benefit may be immediate if the item is a digital good or an in-store purchase. Otherwise, the benefit may be some time in the future if the item is a physical good to be delivered to or collected by the user or a service to be used by the user at a later date.

FIG. 3 is a sample screenshot of a user interface 2000 of a mobile device 100 showing different funding options, according to an embodiment of the present disclosure. In an example scenario, Jack has downloaded the new “Payment Finder” app and saved his cards and personal data. He goes to Harvey Norman to buy a new Wide Screen TV, Blu Ray™ player and Home Cinema Sound System. The total cost for these items is 3600.00.

Jack scans the QR codes on each item, which launches the payment finder app. The payment finder app retrieves available funding options from Harvey Norman and also from Jack's bank and other banks and presents via the payment finder app various funding options according to the items for purchase as follows:
Harvey Norman 10 monthly payments of 360.00 (APR 0%)
Harvey Norman Deposit 360.00 plus 36 monthly payments of 100.00 (APR 21.99%)
L&U Bank Overdraft for 24 months APR 12%
L&U Bank Credit Card payment; Rewards points 36,000
L&U Bank 36 monthly payments of 110.00 (APR 14.99%)
L&U Bank 12 monthly payments of 303.00 (APR 8.99%)

Jack selects the funding option best suited to his needs. If required the system exchanges any personal details needed to complete a new credit application. When the funding option is accepted, Jack confirms payment in the payment finder app and the system fulfills the payment using the existing payments network.

For in-store credit, there may be no need or no option to fulfill the payment.

As described above, the funding options offered may not be restricted to the merchant and user's bank. Third parties offering funding options may be offered access to the sale too.

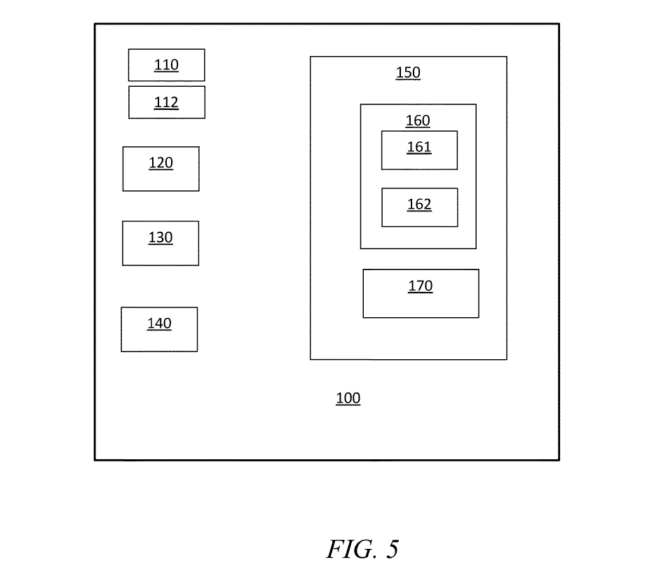

FIG. 5 is a block diagram illustrating a configuration of a mobile device 100 according to an embodiment of the present disclosure. The mobile device 100 includes various hardware and software components that function to perform the methods according to the present disclosure. Referring to FIG. 5, the mobile device 100 comprises a user interface 110, a processor 120 in communication with a memory 150, and a communication interface 130. The processor 120 functions to execute software instructions that can be loaded and stored in the memory 150. The processor 120 may include a number of processors, a multi-processor core, or some other type of processor, depending on the particular implementation. The memory 150 may be accessible by the processor 120, thereby enabling the processor 120 to receive and execute instructions stored on the memory 150. The memory 150 may be, for example, a random access memory (RAM) or any other suitable volatile or non-volatile computer readable storage medium. In addition, the memory 150 may be fixed or removable and may contain one or more components or devices such as a hard drive, a flash memory, a rewritable optical disk, a rewritable magnetic tape, or some combination of the above.

One or more software modules 160 may be encoded in the memory 150. The software modules 160 may comprise one or more software programs or applications having computer program code or a set of instructions configured to be executed by the processor 120. Such computer program code or instructions for carrying out operations for aspects of the systems and methods disclosed herein may be written in any combination of one or more programming languages.

The software modules 160 may include a payment finder app 161 and a merchant app 162 configured to be executed by the processor 120. During execution of the software modules 160, the processor 120 configures the mobile device 100 to perform various operations relating to the facilitating and processing of transactions according to embodiments of the present disclosure, as has been described above.

Other information and/or data relevant to the operation of the present systems and methods, such as a database 170, may also be stored on the memory 150. The database 170 may contain and/or maintain various data items and elements that are utilized throughout the various operations of the contactless payment system described above. The information stored in the database 170 may include but is not limited to, credit card details and billing information unique to the consumer and/or payment method, personal information for each consumer, banking information and a history of transactions by the consumer. One or more digital wallets may be stored in the database 170. It should be noted that although the database 170 is depicted as being configured locally to the mobile device 100, in certain implementations the database 170 and/or various other data elements stored therein may be located remotely. Such elements may be located on a remote device or server—not shown, and connected to the mobile device 100 through a network in a manner known to those skilled in the art, in order to be loaded into a processor and executed.

Further, the program code of the software modules 160 and one or more computer readable storage devices (such as the memory 150) form a computer program product that may be manufactured and/or distributed in accordance with the present disclosure, as is known to those of skill in the art.

The communication interface 140 is also operatively connected to the processor 120 and may be any interface that enables communication between the mobile device 100 and external devices, machines and/or elements including the one or more payment service providers 300 and the merchant terminal 400. The communication interface 140 is configured for transmitting and/or receiving data. For example, the communication interface 140 may include but is not limited to a Bluetooth, or cellular transceiver, a satellite communication transmitter/receiver, an optical port and/or any other such, interfaces for wirelessly connecting the mobile device 100 to the one or more payment service providers 300 and the merchant terminal 400.

The user interface 110 is also operatively connected to the processor 120. The user interface may comprise one or more input device(s) such as switch(es), button(s), key(s), and a touchscreen.

The user interface 110 functions to allow the entry of certain information about the user and preferred funding options as discussed above, and to allow selection of the preferred funding option. The user interface 110 functions to facilitate the capture of commands from the user such as an on-off commands or settings related to operation of the contactless payment system.

A display 112 may also be operatively connected to the processor 120. The display 112 may include a screen or any other such presentation device that enables the user to view various options, parameters, and results. The display 112 may be a digital display such as an LED display. The user interface 110 and the display 112 may be integrated into a touch screen display.

The operation of the mobile device 100 and the various elements and components described above will be understood by those skilled in the art with reference to the method and system for delivering funding options to a user according to the present disclosure.

The present disclosure is not limited to the embodiment(s) described herein but can be amended or modified without departing from the scope of the present disclosure. Additionally, it will be appreciated that in embodiments of the present disclosure some of the above-described steps may be omitted and/or performed in an order other than that described.

What is claimed is:

1. A computer-implemented method for delivering funding options to a user, the method being performed by a mobile device and comprising operating a processor associated with the mobile device to:
allow a user to select an item for purchase;
collate data from one or more payment service provider sources to inform a user of the mobile device of available funding options;
allow user selection of a preferred funding option; and
fulfill the preferred funding option.

2. The method of claim 1, wherein the item selection is effected locally or remotely to the item being selected for purchase.

3. The method of claim 1, wherein the selecting an item for purchase comprises capturing an identifier associated with the item for purchase.

4. The method of claim 3, wherein the selecting an item for purchase comprises at least one of the following:
scanning a barcode or a Quick Response (QR) code associated with the item for purchase;
capturing an image of the identifier;
receiving a speech identifier of the item for purchase; and
providing a user interface on the mobile device for entering the identifier.

5. The method of claim 3, further comprising configuring a user interface on the mobile device to allow a user select a visual identifier associated with the item.

6. The method of claim 1, wherein selecting the item comprises displaying to the user on the mobile device information about the item.

7. The method of claim 6, wherein selecting the item comprises replacing a previous content screen by a screen with a description of the item to be purchased.

8. The method of claim 6, further comprising displaying a pop up or overlay of the previous content page, which allows the user to remain on the previous content page.

9. The method of claim 1, further comprising, on selection of the item for purchase, transmitting a payment request to the one or more payment service providers.

10. The method of claim 9, wherein the payment request comprises an identifier associated with the mobile device.

11. The method of claim 1, further comprising receiving one or more approved funding options from each of the one or more payment service providers.

12. The method of claim 1, further comprising, on selection of the item for purchase, authenticating the user with one or more payment service providers.

13. The method of claim 12, further comprising receiving one or more funding options from each of the one or more payment service providers which has authenticated the user.

14. The method of claim 1, further comprising presenting to the user via a user interface of the mobile device the approved funding options.

15. The method of claim 14, wherein each of the one or more funding options displayed on the user interface may comprise the name of the payment service provider and the terms and conditions of the respective funding option.

16. The method of claim 1, wherein the funding options comprises at least one of:
a debit card option;
a credit card option;
a bank credit line option;
an in-store credit option;
a hire purchase option; and
a loan option.

17. The method of claim 1, wherein the one or more payment service providers sources comprise at least one of the user's bank, a third party payment service provider, and a merchant from which the purchase is being made.

18. The method of claim 1, wherein the one or more funding options includes an option of conducting the transaction using one or more payment service providers.

19. The method of claim 18, wherein the cost of the item for purchase is spread between at least two payment service providers.

20. The method of claim 1, wherein the one or more funding options includes an option of conducting the transaction using one or more transaction types.

21. The method of claim 1, wherein each of the one or more funding options is configured according to at least one of the following: the price of the item for purchase, the credit rating of the user, and an account balance of the user.

22. The method of claim 1, further comprising listing the one or more funding options according to the payment service provider.

23. The method of claim 22, further comprising providing funding options in a list such that an identifier associated with a payment service provider to which the user has preregistered is located at the top of the list.

24. The method of claim 1, wherein fulfilling the selected funding option comprises using a payment network.

25. The method of claim 24, further comprising fulfilling the selected funding option using a digital wallet provided on the mobile device.

26. The method of claim 25, wherein the digital wallet enables storage of one or more records that can be used for online and offline purchases.

27. Then method of claim 25, wherein each record is associated with a financial account that can be used to make a purchase.

28. The method of claim 27, wherein the financial account is associated with the user.

29. The method of claim 27, wherein the financial account comprises a credit card account, a debit card account, a checking account, a savings account, or a loyalty rewards account.

30. The method of claim 29, wherein fulfilling the selected funding option comprises exchanging data to allow payment fulfillment offline.

31. The method of claim 30, further comprising transmitting information identifying the user saved in the mobile device to the payment service provider providing the selected funding option.

32. The method of claim 31, wherein fulfilling the selected funding option comprises using an in-store credit facility.

33. The method of claim 32, further comprising creating a new record in the digital wallet in order to facilitate fulfilling the selected funding option.

34. The method of claim 33, further comprising adding, modifying, or removing registration information identifying the user to or from the digital wallet to create a new record.

35. The method of claim 1, wherein the registration information is received via a user interface on the mobile device.

36. The method of claim 1, wherein fulfilling the payment comprises receiving from the payment service provider notification of an addition of a charge or amount corresponding to the price of the item to the account of the user.

37. The method of claim 1, further comprising authorising the payment service provider to credit an account associated with the merchant with the purchase amount.

38. The method of claim 1, further comprising receiving a payment confirmation at the mobile device.

39. The method of claim 1, further comprising receiving a digital payment receipt at the mobile device.

40. The method of claim 1, wherein the method steps are implemented in a payment finder app on the mobile device.

41. The method of claim 40, wherein selection of the item for purchase triggers the launching of the payment finder app.

42. A mobile device configured to deliver funding options to a user, the mobile device comprising:
a memory;
a user interface; and
a processor configured to:
allow a user to select an item for purchase;
collate data from one or more payment service provider sources to inform a user of the mobile device of available funding options;
allow user selection of a preferred funding option; and
fulfill the preferred funding option.

43. A non-transitory computer readable medium comprising computer executable instructions which when executed by a mobile computing device cause the mobile computing device to perform the method of:
allowing a user to select an item for purchase;
collating data from one or more payment service provider sources to inform a user of the mobile device of available funding options;
allowing user selection of a preferred funding option; and
fulfilling the preferred funding option.
